(19) United States
(12) Patent Application Publication
(10) Pub. No.: US 2026/0365434 A1
(43) Pub. Date: Nov. 19, 2026

(54) SYSTEM AND METHOD FOR MANAGING THE LOADING AND UNLOADING OF TIRES IN AN UNKNOWN ARRANGEMENT

(71) Applicant: COMPAGNIE GENERALE DES ETABLISSEMENTS MICHELIN, Clermont-Ferrand (FR)

(72) Inventors: JEAN-MARIE DETTORRE, Clermont-Ferrand (FR); MOHAMED-ABBAS KONATE, Clermont-Ferrand (FR); NICOLAS BARD, Clermont-Ferrand (FR); KEVIN BOUVET, Clermont-Ferrand (FR); FABRICE DA-COSTA, Clermont-Ferrand (FR)

(21) Appl. No.: 19/137,050

(22) PCT Filed: Oct. 26, 2023
(86) PCT No.: PCT/EP2023/079895

§ 371 Date: Jun. 9, 2025

(30) Foreign Application Priority Data
Dec. 14, 2022 (FR) 2213312

(51) Int. Cl. B65G 1/137; B65G 61/00

(52) U.S. Cl. CPC B65G 1/1378; B65G 61/00; B65G 2201/0273

(57) ABSTRACT

The invention relates to a method for managing the loading and unloading of tyres arranged in an unknown arrangement, the management method comprising the following steps: —a step of performing a picking process in a loading space; —a step of performing a process of loading one or more target locations; —a step of transporting the loaded target locations to a processing space; —an unloading step performed in the processing space;-a step of collecting tyres as a function of one or more orders received at a management facility (500); —a loading step during which a device (100) picks up identified tyres and arranges them in an assigned target location (550); and —a step of positioning the loaded target locations in one or more distribution systems serving the management facility.

### TECHNICAL FIELD

The invention relates to a system that implements a method for loading and/or unloading tyres in an unknown arrangement. More particularly, the invention relates to a workshop organization that makes it possible to optimize the loading and unloading of tyres in order to transport them without prior knowledge of their precise configuration.

### CONTEXT

In the field of tyre picking, tyre arrangements exist that make the tyres easier to handle and that allow them to be optimally stored in the available storage space. With reference to FIG. 1, one embodiment of tyre storage is shown in which several layers of tyres 10 partially overlap one another. In this type of tyre storage (known in the art as a “rick-rack” arrangement), the tyres are stacked in a container 12, with the direction of overlapping being reversed from one layer to the next. In this configuration, the space between lateral parts 12a of the container 12 is optimally used. The container 12 can be selected from among the known containers for transporting tyres, including, but not limited to, pallets, open-bodies of trucks, chain-bound beds of trucks, box-bodies of trucks or vans and equivalents thereof. The structure of this stacking pattern is described in detail in patent DE2426471A1.

Other types of tyre storage are also known for transporting such tyres in containers. In one tyre storage embodiment known as “roll storage”, the tyres are stored next to one another on their tread along a common horizontal axis. In one tyre storage embodiment known as “stacked storage”, the tyres are stacked next to one another on their sidewalls along a common vertical axis.

Automated solutions exist for stacking the tyres in containers according to the selected type of storage. These solutions incorporate vision-based control of a robot in the context of grasping tyres by gripping. Examples are provided in patent U.S. Pat. No. 8,244,400 (which discloses a device for the automated stacking of tyres on a support that comprises a handling device with one or more gripping tools coupled for receiving and setting down the tyres), patent U.S. Pat. No. 8,538,579 (which discloses a depalletization system for implementing a method for depalletizing tyres set down on a support, the system being guided by a robot with a gripping tool), and patent U.S. Pat. No. 9,440,349 (which discloses an automatic loader/unloader of tyres for stacking them on/unstacking them from a trailer, comprising an industrial robot capable of a selective articulated movement).

Picking technologies often use a combination of a laser scan of the surface assumed to contain the objects to be picked up and knowledge of the object being sought (CAD). The system seeks to superpose the elements measured in the actual space with the elements known from the CAD in order to precisely find the object and its spatial configuration in order then to be capable of grasping it in the manner that is consistent with the design of the gripper. The majority of the methods used in industry thus work by trying to control the environment.

From a hardware standpoint, this can be done by requiring facilities that are highly specialized for that task, either by learning references in the fixed working environment, or by attempting to realign a CAD model in a scene of the point cloud type in order to detect an object.

A method requiring a specific physical facility, however sophisticated it might be, will no longer work if there are significant variations in the facility. A model realignment requires all the objects in the container to be identical (to within a scaling factor) and to be largely visible in order to achieve suitable matching. For example, patent U.S. Pat. No. 8,538,579 proposes using the CAD data of the tyres to perform the “storage densification” work. This requires either a completely uniform pallet of identical tyres, the dimension of which is captured once and then the system processes them automatically, or that the tyre reference be read on a case-by-case basis, its dimensions looked up in a CAD database, calculation of its optimal storage position, and then the handling of the tyre.

In addition, there are storage means specific to the tyres other than product recognition. For example, patent EP2062824B1 discloses individual boxes that facilitate the transport of cylindrical articles such as tyres. In particular, a folded box is disclosed that makes it possible to handle the tyres and store them in a stable manner. As a result, the storage of the boxes themselves leads to a significant loss of space and high costs.

In another example of storage means specific to tyres, patent U.S. Pat. No. 9,580,236 discloses a storage and transport container comprising members and posts that make it possible to hold unstable products (such as tyres) in place. The container comprises a rotatable gate rotatably attached and able to be lockably secured by means of a spring loaded gate lock attached to the rotatable gate and configured to slide into a corresponding hole. However, the manner in which said container is filled and/or emptied is not addressed.

The tasks of filling and emptying known containers for transporting tyres (and in particular, trucks) are by definition uncertain: the sequence of the laced tyres is not known in advance, and neither is their dimension; accessibility is poor, and accessibility for gripping is likewise poor; and the tyres can be only partially seen. Controlling the environment is not therefore viable.

Establishing a link between picking processes and managing the loading (and unloading) of tyres arranged in an unknown arrangement thus makes it possible to perform the processing of the tyre orders received at a management facility in a predetermined sequence. The invention disclosed associates the parameters of the tyres and facilitates the collecting and transport thereof as a function of the given received orders.

### SUMMARY OF THE INVENTION

The invention relates to a method for managing the loading and unloading of tyres arranged in an unknown arrangement, the method being implemented by a system that makes it possible to execute programmed instructions stored in a memory of one or more processors of the system in order to manage the movement of a picking device in order to optimize the fulfilment of the tyre orders received, characterized in that the management method comprises the following steps:
a step of performing a picking process in a dedicated loading space of a management facility incorporating one or more target locations for the tyres intended for picking;
a step of performing a process of loading one or more dedicated target locations for processing orders received at the management facility before the initiation of the picking process;
a step of transporting the loaded target locations from the loading space to a processing space of the management facility;
an unloading step performed in the processing space of the management facility;
a step of collecting tyres as a function of the orders received at the management facility, during which the unloaded tyres are conveyed to at least one workstation with a fixed robot comprising at least one device assigned to collecting the unloaded tyres intended to fulfil one or more orders in progress;
a step of loading a target location assigned to each workstation, during which the device picks up the tyre or tyres identified during the collecting step and arranges them in the assigned target location; and
a step of positioning the loaded target locations in one or more distribution systems serving the management facility, during which each distribution system is capable of removing the arranged tyres in order to fulfil each order received in a predetermined sequence.

In some embodiments of the management method of the invention, the picking process comprises a process of picking on the basis of the images taken by the picking device, comprising the following steps:
a step of determining one or more parameters of a target tyre in the unknown tyre arrangement, during which the device obtains one or more digital images of the stored tyres in order to identify the tyre that becomes a candidate for picking up, and in which the parameters of the imaged target tyre comprise at least one parameter among the following parameters:
an inner boundary and an outer boundary that together define the boundaries of the sidewall of the target tyre;
a rim radius defined as being the distance between a central point of the target tyre and the inner boundary of the sidewall;
a sidewall inner diameter defined as being twice the rim radius;
a tyre radius defined as being the distance between the central point and the outer boundary of the sidewall; and
a tyre diameter defined as being twice the tyre radius;
a step of determining the diameter of the target tyre;
a step of determining the tyre radius and rim radius of the target tyre;
an approach step in which the device approaches the identified target tyre for picking up;
a picking step in which the target tyre is picked up by the gripper; and
a step of extracting the target tyre from the tyre arrangement in order to place it in a target location;
   wherein, during the step of determining one or more parameters of the target tyre, the picking device obtains one or more digital images of the tyres arranged in an identified target location in order to identify the tyre that becomes the candidate for picking.

In some embodiments of the management method of the invention, the picking process comprises a process of picking on the basis of few-shot learning, comprising the following steps:
a step of acquiring data corresponding to the arranged tyres, during which a detection system of the picking device captures an initial image of the randomly arranged tyres;
a step of feeding an extraction neural network and an attention neural network, during which both neural networks are trained by taking a plurality of sample images obtained during the data acquisition step as training data and a plurality of classifications of objects in images as data labels;
a step of performing a three-dimensional reconstruction process wholly performed based on the data from the extraction neural network and the attention neural network, during which coordinates corresponding to the location of an identified target tyre and its orientation are reconstructed from this data, so that this reconstruction can be used to provide the geometric information required to generate an ideal pick-up point on the identified target tyre;
an approach step in which the picking device approaches the identified target tyre, during which the attention neural network sends the coordinates corresponding to the location of the identified target tyre and its orientation to the picking device; and
a step of extracting the identified target tyre from the tyre arrangement in order to place it in the target location.

In some embodiments of the management method of the invention, the step of feeding the extraction neural network and the attention neural network comprises the following steps:
a step of training the extraction neural network to segment a scene viewed by the detection system of the management system; and
a step of constructing the attention mechanism, during which the attention neural network extracts differentiated properties from among various categories in a target tyre detection model, such that the model is guided in order to locate key areas in a segmented image;
   wherein the step of training the extraction neural network comprises a step of segmenting data based on a plurality of cycles of a repetitive movement of the picking device during one or more picking cycles.

In some embodiments of the management method of the invention, during the step of performing the 3D reconstruction process, the orientation, dimensions and location of the identified target tyre are reconstructed from the data from the extraction neural network and the attention neural network.

In some embodiments of the management method of the invention:
the step of acquiring data of the few-shot learning process comprises a step of constructing a point cloud from RGB-D images; and
the approach step of the picking device comprises a step of picking up the identified target tyre at the ideal pick-up point calculated during the step of performing the 3D reconstruction process.

In some embodiments of the management method of the invention, a step of extracting the identified target tyre comprises a step of transporting the identified target tyre to a predetermined target location, this step being performed by the picking device.

In some embodiments of the management method of the invention, the picking process comprises the following steps:
a step of providing a detection system comprising one or more sensors for capturing one or more images of the physical environment around the picking device incorporating the tyre arrangement and for gathering representative data in the field of view of the sensors; and
a step of providing a processor comprising an image processing module that applies the representative data to a deployed neural network and analyses the captured images in order to determine, using the deployed neural network, one or more parameters of a target tyre imaged in the field of view of the sensors;
   so that the device is set in motion on the basis of the determined parameters of the target tyre,
   so that the gripper can pick up a target tyre selected by the detection system.

In some embodiments of the management method of the invention, the unloading step comprises a step of dumping the tyres received at the facility onto circulation means installed in the processing space of the management facility, which circulation means circulate in a predetermined direction in order to convey the dumped tyres to one or more workstations of the facility.

In some embodiments of the management method of the invention, the collecting step comprises a step of performing a picking process in order to select and collect one or more tyres as a function of an assortment of tyres intended for arrangement in a predetermined target location, during which the robot assigned to a workstation identifies the tyre or tyres intended for arrangement in a target location positioned at the workstation.

In some embodiments of the management method of the invention, one or more steps of the picking process are repeated in a predetermined sequence in order to arrange the tyres in a predetermined target arrangement.

In some embodiments of the management method of the invention, the step of transporting the loaded target locations comprises a step of provisioning transport means, during which the loaded target locations are arranged in the transport means in a predetermined sequence that makes it possible to process the orders received at the facility in a corresponding sequence.

In some embodiments of the management method of the invention, the process further comprises a step of performing a locking method performed by a container used as a target location positioned in at least one of the loading space and a target location assigned to each workstation, the container comprising:
a substantially rectangular retaining frame in order to make it possible to load and retain the tyres in the container;
a pair of substantially identical movable walls;
a depositing platform comprising an upper surface to which the movable walls are tiltably connected, and an opposite lower surface;
   and wherein each movable wall comprises:
an upper part and a lower part that form a system for compacting the container, and wherein:
   the upper part comprises substantially parallel elements having a predetermined length that extends between a control end and an opposite locking end of the upper part;
   the lower part comprises substantially parallel elements having a predetermined length that extends between a fastening end positioned next to the upper surface of the platform and an opposite locking end such that the locking ends are positioned next to each other where the movable walls are placed in an unlocked position, where each respective movable wall remains tilted to allow the loading and arrangement of the tyres in the container, the elements being separated by a predetermined width so that they are substantially aligned with the elements of the upper part;
      wherein the fastening end of the lower part of the container is positioned next to the upper surface of the platform, the fastening end comprising one or more known fastening means that facilitate a tilting movement of each movable wall allowing each movable wall to rise and descend pivotably, making it possible to tilt it between the unlocked position and a locked position, where each movable wall rises to immobilize and firmly position the tyres arranged in the container, in which the elements meet and are locked in order to compact the tyres arranged in the container.

In some embodiments of the management method of the invention, during the unloading step:
each filled container is placed in the processing space of the management facility in reverse loading sequence; and
in the processing space, the upper and lower parts of each movable wall are unlocked, which makes it possible to unload the tyres arranged in the container.

In some embodiments of the management method of the invention, the loading process comprises the following steps:
a step of positioning one or more containers in the picking space of the facility, during which a target container is identified as a target location for the tyres picked during the picking process;
a step of loading the target container during which a picking device arranges the picked tyres in the target container in a planned arrangement based on the parameters of the picked tyres; and
a step of locking the target container in order to press it against the tyres arranged therein, during which the locking ends of each movable wall of the target container move towards each other in order to immobilize the tyres arranged in the target container and keep them in the planned arrangement during the transport of the target container.

Further aspects of the invention will become apparent from the following detailed description.

### BRIEF DESCRIPTION OF THE DRAWINGS

The nature and various advantages of the invention will become more apparent from reading the following detailed description, and from studying the appended drawings, in which the same reference signs denote parts which are identical, and in which:

FIG. 1 shows a perspective view of one embodiment of tyre storage.

FIGS. 2 and 3 show components of a known tyre in a meridian plane.

FIG. 4 shows a partial perspective view of an embodiment of a picking device used in a management system of the invention.

FIG. 5 shows an example of the loading of tyres performed in a picking space by a picking device of the type shown in FIG. 4.

FIG. 6 shows an embodiment of a picking process based on few-shot learning that is performed during an embodiment of the management method of the invention.

FIGS. 7 to 9 show views of a container into which and from which tyres are loaded and unloaded.

FIG. 10 shows a view of transport means in which the loaded containers are transported.

FIG. 11 shows a view of one embodiment of a management facility for managing the assignment and transport of tyres as a function of a loading and/or unloading method therein.

### DETAILED DESCRIPTION

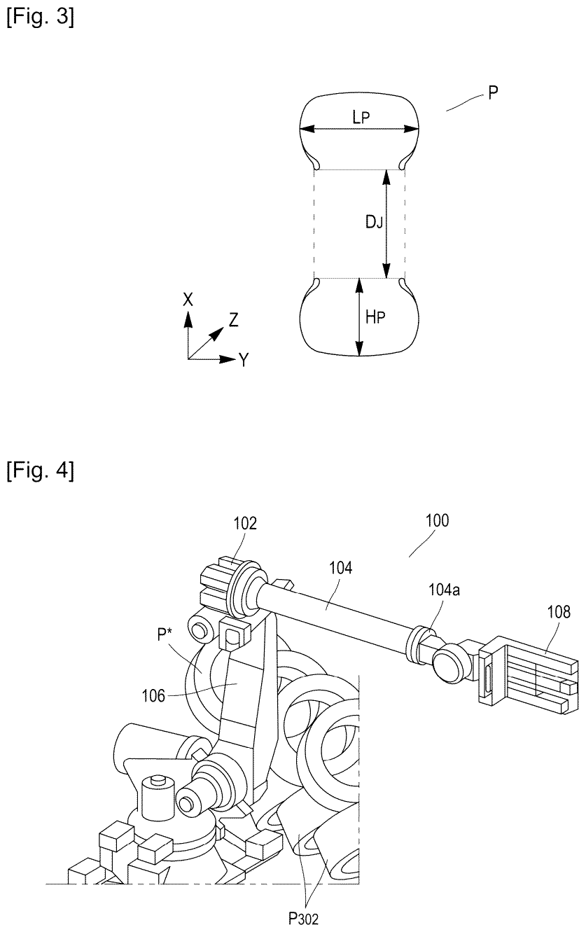

When considering the type of tyre storage that best uses the available storage space, the geometry of the tyres that are being transported must be considered. FIGS. 2 and 3 show schematic diagrams of a tyre P, which comprises, as is conventional, two circumferential beads intended to allow the tyre to be hooked onto a rim. Each bead comprises an annular reinforcing bead wire. The make-up of a tyre is typically described by representing its components in a meridian plane, that is, a plane containing the axis of rotation of the tyre. The radial, axial and circumferential directions respectively denote the directions perpendicular to the axis of rotation of the tyre, parallel to the axis of rotation of the tyre, and perpendicular to any meridian plane. The expressions “radially”, “axially” and “circumferentially” respectively mean “in a radial direction”, “in the axial direction” and “in a circumferential direction” of the tyre. The expressions “radially inner/inside” and “radially outer/outside” respectively mean closer to and further away from the axis of rotation of the tyre, in a radial direction.

With reference to FIG. 2, the tyre P comprises an inner boundary F_{I} and an outer boundary F_{E} which together define the boundaries of a sidewall F of the tyre P. The inner boundary F_{I} separates the sidewall F of the tyre from a rim (not shown) on which the tyre is intended to be mounted. The tyre P also comprises a rim radius R_{J} defined as being the distance between a central point C of the tyre and the inner boundary F_{I} that separates the rim and the sidewall F of the tyre. The tyre P also comprises a sidewall inner diameter defined as being twice the rim radius R_{J}. The tyre P also comprises a tyre radius R_{P} defined as being the distance between the central point C and an outer boundary F_{E} of the sidewall F that represents the tread surface of the tyre. The tyre P also comprises a tyre diameter defined as being twice the tyre radius R_{P}.

With reference to FIG. 3, the inflated and unladen tyre P has several parameters relating to its geometry, including a nominal section width L_{P} and a height H_{P} (with the height H_{P} often being expressed as a percentage of the width L_{P}). The tyre P also has a measurement D_{J} that represents the diameter of a rim on which the tyre is intended to be mounted (this measurement being substantially equal to the sidewall inner diameter F_{I}). It will be understood that each of these parameters can be expressed in equivalent known length measurements (for example in millimetres (mm) or in inches (in)).

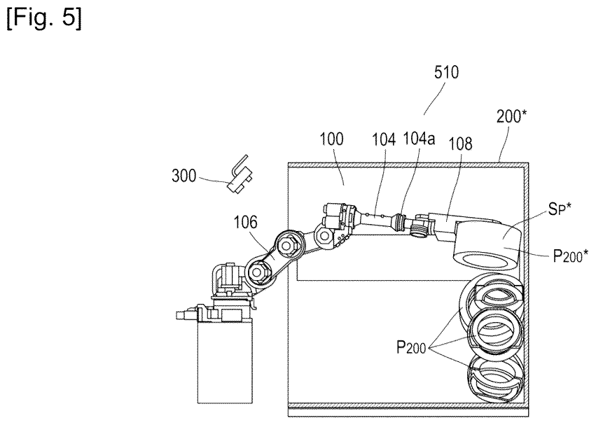

With reference now to FIGS. 4 and 5, in which the same reference signs denote identical elements, FIGS. 4 and 5 show an embodiment of a picking device (or “device”) 100 that picks up a target tyre from an unknown tyre arrangement and for which a target location must be produced during a picking cycle. The device 100 forms part of a loading and unloading management system (or “system”) of the invention.

The term “picking” is given to include the functions of storing and removing arranged (or “picked”) tyres, as well as the target arrangement (including loading and unloading) of the tyres. The term “target tyre” (in the singular or the plural) is used herein to refer to a tyre that is present in the physical environment of the device 100 and that is identified for picking during a picking cycle. The term “target location” (in the singular or the plural) is given to denote a dedicated space in which the tyres are arranged (for example, a belt, a conveyor, a container, a rack, etc.). The term “target arrangement” (in the singular or the plural) denotes a desired arrangement for the tyres arranged in a target location (for example, a “rick-rack”, “roll” or “stacked” storage arrangement).

The system of the invention implements a method for managing the movement of the device 100 (or “management method”) that incorporates a combination of vision techniques to correctly and quickly reconstruct the observed scene based on three-dimensional (or 3D) scattered point clouds originating from a segmented view of the target tyres. In one embodiment of the method for managing the device 100, the system uses few-shot learning to facilitate a storage optimization function aimed at optimizing the gripping of tyres. The system of the invention therefore implements continuous improvement with respect to the selection of the tyres to be picked.

The device 100 can be used in the spaces in which tyres are arranged in an unknown manner and in the spaces in which their target arrangement is to be produced. By way of example, with reference to a picking space 510 of a management facility 500 (see FIG. 11), the device 100 can be used in relation to a container 200 containing picked tyres P₂₀₀. The device 100 can pick up the tyres P₂₀₀ arranged in the container 200 in order to store them in one or more target locations (or, conversely, the device 100 can pick up the tyres arranged in one or more target locations in order to store them in the container 200). It will be understood that any type of appropriate receptacle could be used instead of the container 200.

The device 100 therefore produces a target tyre arrangement in a predetermined target location. It will be understood that the device 100 can operate in several physical environments without prior knowledge of the parameters of such environments (for example, an initial or target arrangement of the tyres in a truck, in a warehouse, in a distribution centre, on a conveyor, on a pallet or with respect to other known storage and/or transport means).

With further reference to FIGS. 4 and 5, in one embodiment of the device 100, the picking device comprises a robot of the type disclosed by WO2022/135968 of the applicant. The robot has a peripheral gripping component 104 supported by a pivoting elongated arm 106.

The peripheral gripping component 104 extends from the elongated arm 106 to a free end 104a, where a gripper 108 is positioned along a longitudinal axis. The robot is set in motion so that the gripper 108 can pick up a target tyre identified by the device 100 during a management method implemented by the system of the invention (as described below). It will be understood that configuration of the device 100 is given by way of example. For example, the device 100 can comprise a fixed robot installed in a picking facility, and attached, for example, to a support from which the robot extends. In this case, it will be understood that the robot can be attached to a ceiling, a wall, a floor or any support that allows the management method of the invention to be implemented. It will be understood that the device 100 can comprise at least one roaming robot. “Roaming” is given to mean that the picking device can be set in motion either by integrated movement means (for example, one or more integrated motors) or by non-integrated movement means (for example, one or more movable means including autonomous movable means). It will be understood that the picking device can be a conventional industrial robot or a collaborative robot or even a delta or cable robot.

The device 100 also comprises a detection system (not shown) for gathering information relating to the physical environment around the device. The detection system comprises one or more sensors (including one or more cameras) configured for performing detection of two-dimensional (2D) and/or three-dimensional (3D) images, 3D depth detection, and/or other types of detection of the physical environment around the picking device (it will be understood that the terms “sensor” and “camera” are used interchangeably). In the embodiments of the device 100 of the type shown in FIGS. 4 and 5, the sensor or sensors of the detection system are attached to at least one of the elongated arm 104 and the gripper 108 of the robot.

In one embodiment of the device 100, the detection system comprises at least one camera that provides 3D images represented as a set of 3D points with coordinates X, Y, Z, and sometimes red, green, blue colour values (“RGB” or “RGB-D” format) (known as “an RGB-D type camera”). In this embodiment, an RGB-D type camera is attached to at least one of the elongated arm 104 and the gripper 108 of the device 100. Two or more RGB-D cameras can be oriented so that a predetermined overlap is obtained between the fields of view of the cameras. As used herein, the term “camera” includes one or more cameras.

RGB-D cameras generally provide depth information using depth maps, which are images in which each pixel contains the distance between the camera and the corresponding point in space. Compared to conventional measurement methods, such as manual measurement and other measurements based on electronic devices, 3D point cloud data originating from RGB-D type cameras have a much higher measurement rate. Using a sparser structure, a point cloud can be constructed from RGB-D images by computing the real world (for example, the coordinates X, Y, Z) with the intrinsic data of a digital camera. Information relating to the physical environment around the device 100 is thus obtained from the 3D point cloud data obtained using detection technologies that are capable of accurately and efficiently capturing the 3D surface geometries of the target tyres.

The term “point cloud” (in the singular or the plural) is used herein to refer to one or more collections of data points in space. One or more cameras (or one or more equivalent devices) gather three-dimensional (3D) data and detect the surfaces of the objects (for example, of the arranged tyres) by virtue of a series of coordinates. Storing the information in the form of a collection of spatial coordinates can make it possible to save space, since many objects do not fill a large part of the environment. Even if the information is not visual, interpreting the data as a point cloud helps to understand the relationship between a plurality of variables by means of classification and segmentation.

The detection system of the device 100 detects the presence of a tyre arrangement in the field of view of the detection system (for example, the field of view of a camera of the device 100), which triggers it to capture the image of a target tyre (see, for example the target tyres P_{200*} shown in FIG. 5). In all of the embodiments of the device 100, the system “searches” the image obtained by the detection system for the presence of a tyre in the environment around the device 100. If no tyre is detected, the detection system continues to obtain the images until the search of the environment around the device 100 is exhausted.

The detection system can determine the information relating to the physical environment that can be used by a control system (which for example comprises software for planning the movements of the device 100). The control system could be located on the device 100 or it could communicate remotely with the device. In some embodiments of the device, one or more 2D or 3D sensors mounted on the device 100 (including, non-limitingly, navigation sensors) can be integrated in order to form a digital model of the physical environment (including, where applicable, the side or sides, the floor and the ceiling). Using the data obtained, the control system can cause the device 100 to move in order to navigate between the target tyre picking positions.

In order to properly manage the handling of the device 100 to ensure that the target tyre is safely picked up (for example, the handling of the robot and the positioning of the gripper 108 as shown in FIGS. 4 and 5), the arrangement of the arranged tyres must be detected and the ideal target tyre for picking up must be identified. The detection data thus refers to a plurality of records representing the locations of at least one tyre or part of a tyre tracked over time. For example, the detection data can include one or more positions among the records of the positions of a reference point on part of the tyre (for example, the sidewall) over time or at defined time intervals; sensor data taken over time; a video stream that has been processed using a computer vision technique; and/or data indicating the operating status of the device 100 over time. In some cases, the detection data can comprise data representing one or more continuous movements of the picking device before it stops to take one or more images of the arranged tyres. The detection system of the device 100 is therefore configured to generate the movement data of the device.

In some embodiments of the invention, the detection system of the device 100 can also comprise a movement capture device selected from infrared sensors, ultrasonic sensors, accelerometers, gyroscopes, pressure sensors, and/or other equivalent devices. By way of example, a movement capture device of the system of the invention can comprise one or a pair of digital gloves for carrying out remote management movements of the device 100. In these embodiments, the system (and particularly the device 100) learns the movements that achieve the target tyre arrangement without operator intervention during subsequent picking processes.

In one embodiment of a picking process performed by the device 100 (and/or by an equivalent device), the system of the invention constructs a virtual tyre as disclosed in WO2022/135968 of the applicant. In this embodiment, the system constructs a virtual tyre in the form of a cylinder on the visible surface of the cluster representing a target tyre using a two-step estimation method:

First of all, an estimation of the median plane of the point cloud is made. This step comprises a step of injecting the result by merging data on the same point cloud in order to estimate the axis, the diameter and the centre of the target tyre.

Next, the device 100, via the decision-making algorithm, selects the tyre to pick up, this algorithm being made up of a parallelized virtual simulation between a simplified geometric model of the gripper and the set of tyres in the previously reconstructed scene. The first tyre that can be picked up is picked up, this being the “target tyre”.

These steps are performed simultaneously on all of the arranged tyres via a parallelization performed by the processor used.

In this embodiment of the picking process performed by the device 100, the camera captures one or more images of the target tyre. The image or images captured are transferred and stored as captured images in the memory of the processor. The processor, which executes the instructions of an image processing module of the processor, analyses the image in order to determine one or more parameters of the imaged tyre. The parameters of the tyre are generally the parameters of the tyre that define the boundaries of the sidewalls of the tyre or the region occupied by the sidewalls of the tyre (see FIGS. 2 and 3). The detection of the sidewall, for example, can identify the points at which the brightness of the image changes sharply, for example the points at which there are discontinuities, and thus distinguish the location of the sidewall of a tyre in the image from the background of the image. The processor can detect changes in the properties of the pixels in order to identify at least part of the sidewalls of the target tyre. The changes in colour of the pixels, for example, can allow the processor to differentiate between the sidewall of the tyre and the background of the image (the boundary between the sidewall of the target tyre and the visible outer radius of the sidewall of the target tyre). In this way, the processor can identify the sidewalls of the target tyre and count the number of pixels between the inner radius of the sidewall of the target tyre (if known) and the outer radius of the sidewall of the target tyre. By using an equation that converts pixels into length, the processor can convert the pixel measurements into measurement units (for example into centimetres, millimetres, inches or another equivalent measurement) in order to determine the height of the sidewall of the tyre. Other parameters of the target tyre can also be determined.

The data from the sensors of the detection system can be applied to an ROI determiner that can exploit one or more machine learning models in order to generate the shapes of the target tyre. Although the embodiments are described herein with regard to the use of neural networks (and more particularly convolutional neural networks (CNNs)) as the machine learning model, other types of machine learning model can be used. These include, non-limitingly, models employing linear regression, logistic regression, decision trees, support vector machines, naive Bayes, K-nearest neighbour (kNN), with K signifying a grouping, random forest, dimensionality reduction algorithms, gradient algorithms, neural networks (for example autoencoding networks, CNNs, RNNs, perceptrons, logarithmic short-term memory (LSTM), Hopfield, Boltzmann, deep belief networks, deconvolution, generative adversarial networks (GANs), etc.) and complements and equivalents thereof. The one or more CNNs can be formed using ground-truth data generated using sensor data representing the movement of the device 100, including the positioning of the gripper 108.

In some embodiments, the processor can configure the device 100 (and in particular the gripper 108) on one or more parameters of the target tyre calculated by the image processing module. The processor can also refer to a reference (for example, a look-up table of various tyre sizes) for making a final determination of the one or more target tyre parameters. The reference can include known tyre parameters corresponding to a plurality of known commercially available tyres. For example, after the image processing module has calculated one or more tyre parameters, the processor can compare the calculated tyre parameters with the known tyre parameters recorded in the reference. The processor can retrieve the known tyre parameters corresponding to the commercially available tyres that most closely correspond to the calculated tyre parameters in order to configure the gripper 108. The tyre reference can include measurements corresponding to a plurality of commercially available tyres. By way of example, for a tyre of size 225/50R17, the number “225” identifies the cross section of the tyre in millimetres, the number “50” indicates the aspect ratio of the sidewall, and the measurement “R17” represents the diameter of the rim in inches (which is approximately 43.18 centimetres).

In order to implement this embodiment of the picking process, the system of the invention comprises an image processing module that analyses the image of the arranged tyres in order to identify a candidate that will serve as the target tyre for picking. The image processing module finds the central point C of the target tyre and the rim radius R_{J}. As the central point C is already known, the image processing module can determine the distance corresponding to the tyre radius R_{P} of a target tyre (for example, the radius of the target tyre can be determined by Pythagoras' theorem using vertical and horizontal distances between points in the point clouds and boundaries of the image obtained). Once the rim radius R_{J} and the tyre radius R_{P} are known, the target tyre parameters that are needed for configuring the gripper 108 can be determined. The image processing module can use these dimensions R_{J}, R_{P} as indices in the tyre-size reference in order to determine the corresponding tyre sizes and/or the tyre parameters that must be used in order to configure the gripper 108. The resulting tyre parameters can then be used to configure the gripper 108 so that the picking up of the target tyres is substantially limited to the inner boundary F_{I} of the sidewall F.

The size of the target tyre can be determined by measuring one or more chords (for example if the chord is measured at a known height). Once the centre C is known, the maximum horizontal distance can be used to determine the rim diameter. In one embodiment, the rim radius R_{J} can be determined using the relationship:

chord length=2√{r²−d²}

where r is the radius of the circle, and d is the perpendicular distance from the chord to the centre of the circle. Other geometric relationships can also be used to determine the parameters of the target tyre as a function of the particular image processing techniques used and the amount of information contained in the image (for example, the quantity of tyres imaged, in full or in part). The mathematical representations of the objects can also be used to detect anomalies, such as one or more individuals entering the physical environment. Such events can contravene the ideal model, which can make them easier to detect.

Using this information, the device 100 can direct the gripper 108 to the theoretical centre of the target tyre, corrected by the half-width of the target tyre. Because the sidewall height is unknown, the adaptation of the gripper 108 to the algorithm used allows the gripper to work it out by “palpation” (that is, perception). The gripper 108 is therefore equipped with this perception which will also prove beneficial in the reverse case, when lacing. Specifically, the gripper 108 is capable of providing the external perception (conferred, for example, by the camera) with information regarding the diameter of the tyre, without seeing the tyre “from above”. This information is relevant when arranging the tyres (for example when lacing), because it is via the inner diameters that the tyres are nested (see, for example, patent U.S. Pat. No. 9,440,349). The gripper 108 can therefore lock the target tyre so that the device 100 can extract it from its arrangement and take it to the depositing site during the picking process.

Once the one or more tyre parameters defining the boundaries of the sidewall of the target tyre have been determined, the processor configures the device 100 (in particular the gripper 108) as a function of the tyre parameters in order to limit the picking up of the target tyre to the boundaries of the sidewall of the tyre.

When this embodiment of the method is initiated, the method comprises a step of determining one or more parameters of a target tyre P* in a tyre arrangement. During this step, the management system (and/or the device 100) obtains one or more digital images of the arranged tyres (for example, the tyres P₂₀₀ in the container 200 as shown in FIG. 5) in order to identify the tyre that becomes a candidate for picking. During this step, the image of the target tyre (for example, the target tyre P₂₀₀*) is analysed to identify one or more front vertical edges B_{AV} of the tyre in the image (see FIG. 2). During this step, the processor can continue to scan until the inner boundary F_{I} of the sidewall F is identified. During this step, the distance between the front vertical edge B_{AV} and the inner boundary F_{I} is measured in order to determine a height H₁ of the sidewall F of the target tyre. During this step, the data corresponding to the front vertical edges B_{AV} can be used to identify a mid-line M of the target tyre. During this step, the processor can then analyse the image of the target tyre and of the inner boundary F_{I} to calculate the inner boundary F_{I} and a rear vertical edge B_{AR}.

It will be understood that the camera can capture an image of just part of the target tyre P*, or the image of the target tyre P* can be obstructed by objects in the physical environment (including, non-limitingly, other tyres, one or more operators, one or more rails, etc.). The parameters of the target tyre are determined in both instances, namely when there is no obstacle hiding the target tyre and when at least part of the target tyre is hidden by one or more obstacles (including one of the other tyres arranged with the target tyre).

In this embodiment of the picking process, the process further comprises a step of determining the diameter of the target tyre. This step comprises determining a distance between the imaged front vertical edge B_{AV} and the calculated rear vertical edge B_{AR}. This step comprises determining a distance between the inner boundary F_{I} of the sidewall F and the rear vertical edge B_{AR} in order to calculate a mean sidewall height H₂ corresponding to the size of the target tyre.

It will be understood that a virtual environment comprising a 2D and/or 3D model of the arranged tyres can be determined and used to formulate a plan or strategy for picking up the tyres. For example, the device 100 can use one or more sensors to scan a physical environment containing the arranged tyres and the one or more target locations. The elongated arm 106 and/or the peripheral gripping component 104 move, with one or more sensors on the elongated arm and/or the peripheral gripping component being able to capture data corresponding to the arranged tyres so as to determine the shapes and/or the positions of the individual tyres.

In this embodiment of the picking process, the method further comprises a step of determining the tyre radius R_{P} and rim radius R_{J} of the target tyre. During this step, the tyre radius R_{P} of the target tyre can be determined as being half the diameter of the target tyre.

During this step, the rim radius R_{J} of the target tyre can be determined as being half the diameter of the inner boundary F_{I} of the sidewall of the target tyre. During this step, the central point C can be identified as being a distance from the rim radius R_{J} to the front vertical edge B_{AV} or to the rear vertical edge B_{AR} and situated along the mid-line M.

Knowing the tyre radius R_{P} and the rim radius R_{J} of the target tyre P* would allow the image processing module to determine the location of the inner boundary F_{I} and outer boundary F_{E} of the sidewall F of the target tyre. Knowing the mean height H₂ of the sidewall and the tyre radius R_{P} of the target tyre would allow the processor to determine the size of the target tyre. The relevant parameters of the target tyre can thus be determined, for example, from the tyre-size reference, or generated by an equation.

In this embodiment of the picking process, the method further comprises an approach step in which the device 100 approaches the identified target tyre for picking up. This step comprises an approach step in which the gripper 108 approaches the target tyre.

In this embodiment of the picking process, the method further comprises a final step of picking up the target tyre at a pick-up point of the target tyre.

In another embodiment of a picking process implemented by the system of the invention incorporating the device 100 (and/or an equivalent device), the system of the invention performs a learning process on the basis of a single example or a small number of examples (known as few-shot learning or FSL). Few-shot learning can reduce the data collection load for data-intensive applications (in particular image classification and video event detection), helping to alleviate the burden of large-scale supervised data collection (see “One-Shot Learning of Object Categories”, Fei-Fei, Li, Fergus, Rob and Perona Pietro, IEEE Transactions on Pattern Analysis and Machine Intelligence, Vol. 28, Issue 4, pg. 594-611 (April 2006) (https://doi.org/10.1109/TPAMI.2006.79). This process is performed as disclosed in application FR2113035 of the applicant.

In this embodiment of the picking process performed by the device 100, the few-shot learning process uses an attention mechanism to pick target tyres. The few-shot learning process benefits from a neural network structure allowing it to focus only on tyres that are suitable for being picked by immediately recognizing them. This makes the device 100 (and therefore the system of the invention) faster and more robust since it knows how to adapt to all of the tyre orientations it sees. In addition, the adaptation to the tyre arrangements is achieved irrespective of the configuration of the picking device of the management system.

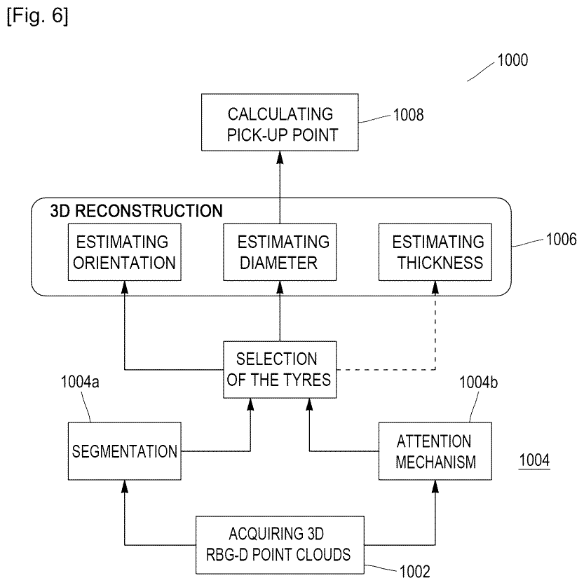

With reference to FIG. 6, the few-shot learning process 1000 comprises a step 1002 of acquiring the data corresponding to the arranged tyres. During this step, the detection system (for example, an RGB-D camera 300 of the management system of the invention and/or of the device 100) (see FIG. 5 and FIG. 11) captures an initial image of the tyres P₂₀₀ arranged randomly in an unknown location (for example, the container 200) (see FIG. 5). In this example, a plurality of overlapping tyres P₂₀₀ appears in the field of view of the detection system. During this step, a point cloud is constructed from the RGB-D images as described above.

The few-shot learning process 1000 also comprises a step 1004 of feeding an extraction neural network (or “extraction network”) and an attention neural network (or “attention network”). This step comprises a step 1004a of training the extraction network to segment the scene viewed by the detection system. In one embodiment of the method, this step can comprise a step of segmenting the data based on a plurality of cycles of a repetitive movement of the picking device during one or more picking cycles. The segmentation carried out during this step differentiates between an object in the image that comprises a tyre (either a whole tyre or a partial tyre) and an object in the image that does not comprise any tyres.

During the feeding step 1004, the extraction network and the attention network are trained by taking a plurality of sample images (obtained during the acquisition step 1002) as training data and a plurality of classifications of objects in images (or heat maps) as data labels. By way of an example, based on the classification of objects in images, an image can be evaluated in order to determine whether the image is capable of attracting the attention of the detection system after the image comprising the tyre targeted for picking up is fed back to the detection system. During this step, the RGB-D camera provides information relating to the depth of the arranged tyres.

The feeding step 1004 comprises a step 1004b of constructing an attention mechanism.

During this step, the attention network extracts differentiated properties from various categories in a target tyre detection model (or “model”), such that the model is guided to locate key areas with important properties in a segmented image (that is, an image incorporating the tyre most suitable for picking up). The model provides better monitoring in the key areas in order to learn any differences among easily confused categories (for example, the tyre most suitable for picking up among the arranged tyres on the basis of a labelled set of images). The accuracy of detecting the target tyre in the image is therefore improved so as to be able to select the target tyre identified for picking up.

In this embodiment of the picking process, the process 1000 further comprises a step 1006 of performing a three-dimensional (3D) reconstruction process that is used to provide the geometric information required to generate the ideal pick-up point for the picking device (for example, picking up by a gripper 108 of a device 100). The 3D reconstruction process comprises a reconstruction process that is wholly carried out on the basis of the data from the extraction and attention networks. During this step, the orientation, dimensions and location of the identified target tyre are reconstructed from this information data. In so doing, the management system (including the device 100) has recognized the arranged tyres (including their orientations and positions) from examples of tyres during the few-shot learning process. During this step, the management system constructs a virtual tyre in the form of a cylinder on the visible surface of the cluster representing a target tyre. During this step, the centre of the identified target tyre is identified in order to estimate its inner and outer diameters (with the inner diameter being represented by twice the rim radius R_{J}, as discussed above with reference to FIG. 2). Once the attention network learns the location of the target tyre and its orientation, it sends the corresponding coordinates (for example, the X, Y, Z coordinates and the orientation of the tyre axis) to the device 100. At this stage of the process, routing plans and distance conversions are already made in order to extract the identified target tyre. Thus, the management system has dictated the expected information fed back from the detection system (namely the RGB-D camera). Consequently, the device 100 applies the movements needed to pick up and release the target tyre at the ideal pick-up point.

The management method of the invention further comprises an approach step in which the device 100 approaches the identified target tyre for picking up. This step comprises an approach step in which the picking device approaches the identified target tyre (for example, the target tyre P_{200*} shown in FIG. 5). This step further comprises a step of picking up the identified target tyre at the ideal pick-up point (for example, as calculated during the step 1006 of performing the 3D reconstruction process). For the configuration of a device 100 as shown in FIGS. 4 and 5, during this step, the gripper 108 is managed so that it engages a sidewall of the target tyre P_{200*} (for example, by extending one or more fingers of the gripper towards a pick-up point of the inner boundary Fr of the sidewall F). It will be clearly understood that the implementation of the method of the invention is not limited by the configuration of the picking device of the management system.

The management method of the invention comprises a final step of extracting the identified target tyre from the tyre arrangement in order to place it in a target location. This step comprises a step of transporting the identified target tyre to the target location that is performed by the picking device.

The management system of the invention can easily repeat the steps of the management method in a sequence for properly arranging the tyres in a target arrangement.

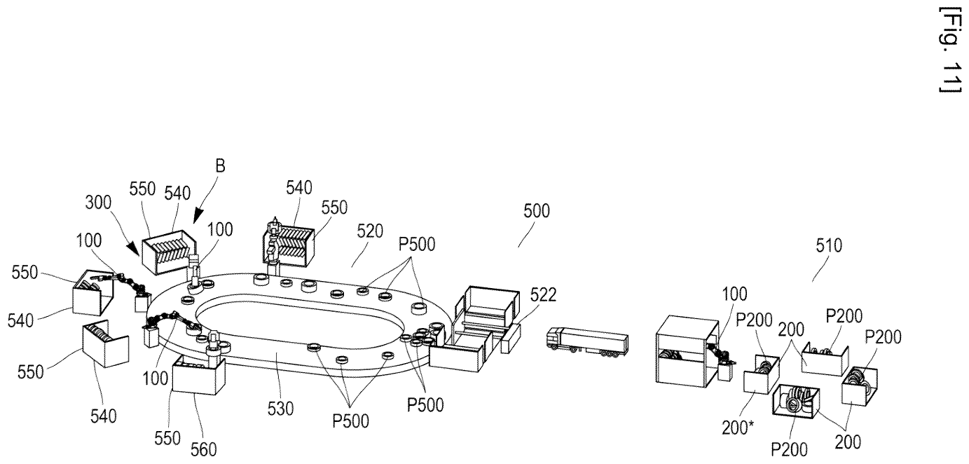

With reference to the device 100, the initial positioning thereof (and, where applicable, the initial orientation of the gripper 108) is determined from data obtained via the acquisition of images of the management system and the physical environment in which the management system operates (for example, as shown in FIG. 11). A module for executing the analysis application of the processor uses an automatic and adaptive repositioning algorithm to find an ideal starting position of the device 100, therefore making it possible to execute programmed instructions stored in the memory in order to pick up an identified target tyre from storage and/or transport means (for example, a truck 400 (see FIG. 10), a management facility 500 (see FIG. 11), a warehouse, a pallet or one or more equivalent means) in which the tyres are arranged. The algorithm allows continuous improvement across all of the tyre picking operations, ensuring that the management system (and particularly the picking device) improves from the experience it acquires, in particular regarding the selection of the tyres to extract.

In some embodiments of the management method of the invention, the processor can configure the management system (and in particular the picking device) on one or more parameters of a target tyre calculated by an image processing module. In these embodiments, it will be understood that one or more reinforcement learning means could be used.

A person skilled in the art in this field will acknowledge that there are numerous image processing techniques that can be used in order to select and to determine the parameters of the target tyres. There are several commercially available image processing systems that can be used.

In all of the embodiments of a picking process performed by the management system incorporating at least one device 100, the steps can be carried out simultaneously on all of the arranged tyres by means of a parallelization performed by the processor used. The term “processor” (or, alternatively, the term “programmable logic circuit”) denotes one or more devices capable of processing and analysing data and comprising one or more software packages for processing said data (for example, one or more integrated circuits known to a person skilled in the art as being included in a computer, one or more controllers, one or more microcontrollers, one or more microcomputers, one or more programmable logic controllers (or “PLCs”), one or more application-specific integrated circuits, one or more neural networks, and/or one or more other known equivalent programmable circuits). The processor comprises software for processing the data captured by the subsystems associated with the system of the invention (and the corresponding data obtained) as well as software for identifying and locating variance and identifying the sources thereof in order to correct same. The one or more processors are operationally connected to a memory configured to store an application for analysing the data representing the imaged tyres (and tyre segments). The one or more processors comprise a module for executing the analysis application that processes the images, the one or more processors being capable of executing programmed instructions stored in the memory in order to perform the steps of the method (as described below). The memory can comprise both volatile and non-volatile memory devices. The non-volatile memory can comprise solid-state memories, such as the NAND flash memory and the keep-alive memory (or KAM) for saving various operating variables while the processor is switched off, magnetic and optical storage media, or any other suitable data storage device that retains the data when the device 100 (and/or the management system incorporating the device 100) is deactivated or has lost its power supply. The volatile memory can comprise a static and dynamic RAM that stores program instructions and data, including a learning application.

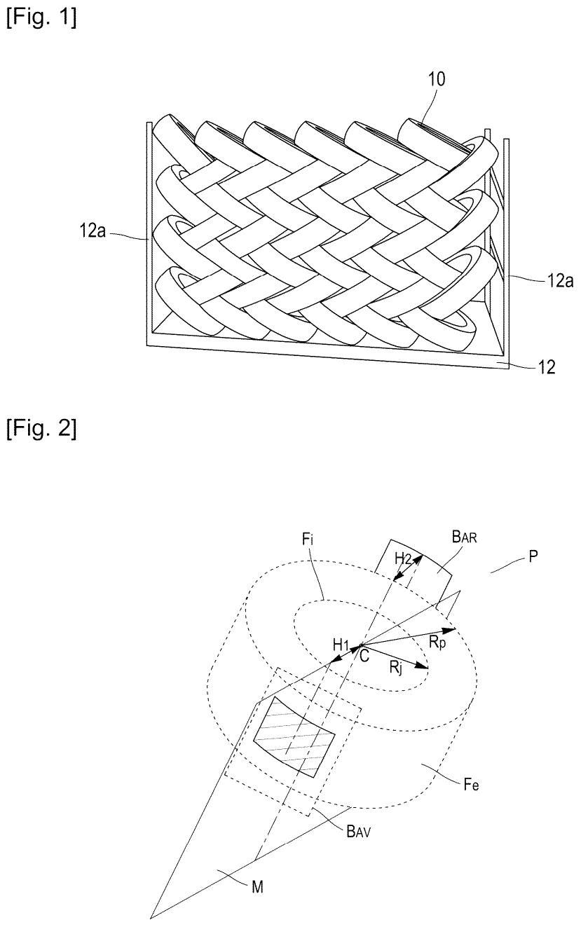

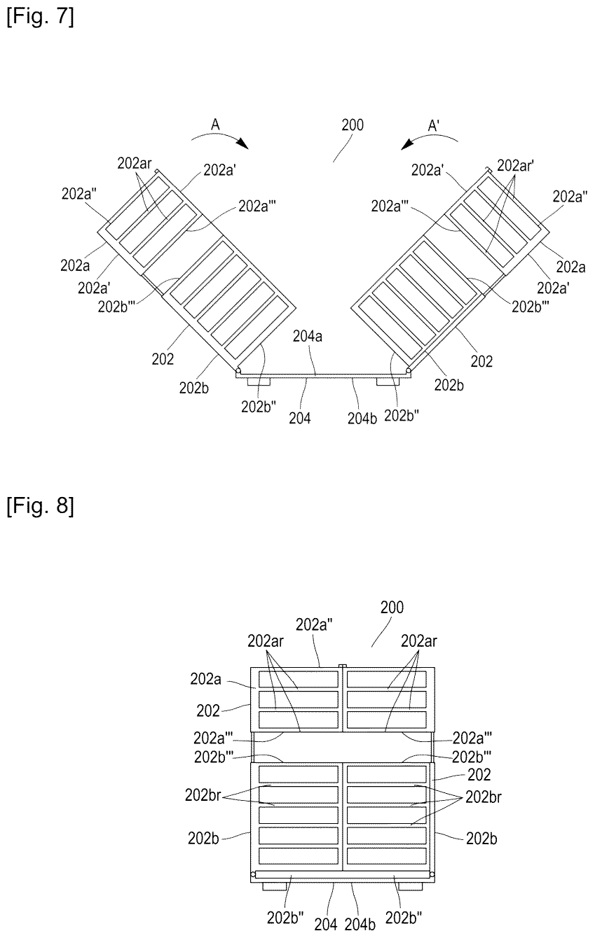

With further reference to FIGS. 1 to 6, and also with reference to FIGS. 7 to 9, the target location of a loading and unloading method of the invention comprises one or more containers 200. The container 200 comprises a substantially rectangular retaining frame in order to make it possible to load and retain the tyres in the container, which makes it possible to manage the tyres during the transport thereof (for example, in a truck 400 as shown in FIG. 10). The container or containers 200 can form part of a tyre management facility (or “facility”) 500 for managing the assignment and transport of tyres as a function of a loading and/or unloading method therein.

With reference to FIGS. 6, 7 and 8, the container 200 comprises a pair of substantially identical movable walls 202 and a depositing platform (or “platform”) 204 relative to which the movable walls 202 tilt. The platform 204 comprises an upper surface 204a to which the movable walls 202 are tiltably connected and an opposite lower surface 204b. In some embodiments of the container 200, the platform 204 can comprise guiding means that facilitate the handling of the container (200) (handling being performed, for example, by automatic handling means of the AGV/RGV type or by another other manual or semi-automatic handling means). By way of example, the guiding means can comprise a pair of guides 204b′ aligned along the lower surface 204b of the platform 204 that facilitate the handling of the container 200 by corresponding handling means (see, for example, the handling vehicle 700 that arranges the containers 200 in the truck 400 shown in FIG. 10).

The arrangement of the tyres involves significant effort to prevent them from moving during the transport thereof in the container 200. Each movable wall 202a thus has an upper part 202a and a lower part 202b that form a system for compacting the container 200. The upper part 202a comprises substantially parallel elements 202a′ having a predetermined length that extends between a control end 202a″ and an opposite locking end 202a″′ of the upper part 202. The elements 202a′ of the upper part 202 are separated by a predetermined width with one or more reinforcements positioned between them (for example substantially parallel rails 202ₐᵣ). The lower part 202b comprises substantially parallel elements 202b′ having a predetermined length that extends between a fastening end 202b″ positioned next to the upper surface 204a of the platform 204 and an opposite locking end 202b″′. The locking ends 202a″′, 202b″′ are positioned next to each other where the movable walls 202 are placed in an unlocked position (in which each respective movable wall 202 remains tilted to allow the loading and positioning of the tyres in the load space of the container 200) (see FIG. 7). The elements 202b′ of the lower part 202b are separated by a predetermined width so that they are substantially aligned with the elements 202a′ of the upper part 202a. One or more reinforcements are positioned between the elements 202b′ of the lower portion 202b (for example, substantially parallel rails 202_{br}). The rails 202ₐᵣ, 202_{br} are shown in a horizontal direction, but it will be understood that they could be replaced by substantially vertical rails, partitions or other suitable equivalent elements.

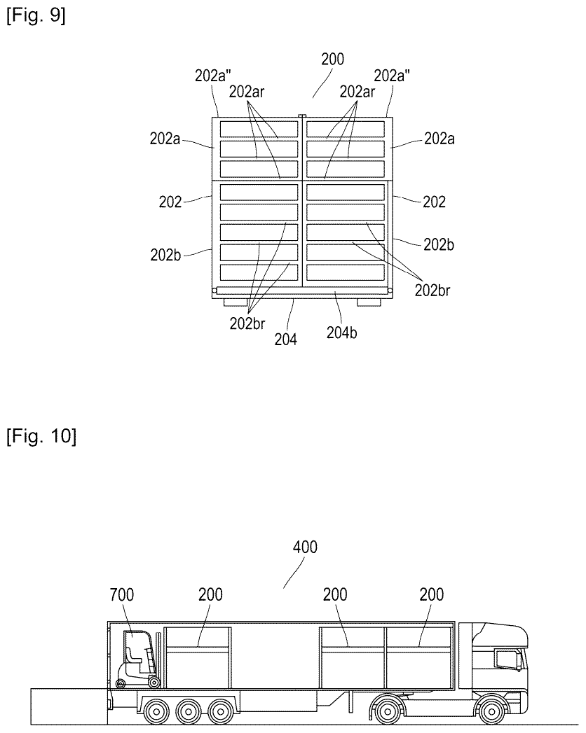

The fastening end 202b″ of the lower part 202b of the container 200 is positioned next to the upper surface 204a of the platform 204. The fastening end 202b″ comprises one or more known fastening means that facilitate a tilting movement of each movable wall 202 (for example a hinge assembly connected to the upper surface 204a of the platform 204). In this configuration, each movable wall 202 rises and descends pivotably, making it possible to tilt it between the unlocked position and a locked position (in which each movable wall 202 rises to immobilize and firmly position the tyres arranged in the container 200) (see FIGS. 8 and 9). In the locked position, the elements 202a′, 202b′ meet, and are locked in order to compact the tyres arranged in the container 200. The locking system of the container 200 thus retains the arranged tyres in the load space of the container during transport cycles and the operations to load and unload containers (performed, for example, with respect to one or more trucks 400 of the type shown in FIG. 10 and/or in a facility of the type represented by the facility 500 in FIG. 11).

The upper part 202a of each movable wall 202 is capable of being placed in linear alternating movement between a standby position (in which the tyres are arranged in the container 200) (see FIGS. 7 and 8) and a closed position (in which the container 200 is in the transport position) (see FIG. 9). When the movable walls 202 are in the locked position, the upper and lower parts 202a, 202b can be locked at the respective locking ends 202a″′, 202b″′. This locking can be achieved by one or more known locking means. By way of example, a spring-loaded coupling system can be used that holds the upper parts 202a in tension in the locked position and, on unlocking, urges them to the unlocked position.

The tilting movement of the movable walls 202 and/or the linear alternating movement of the upper parts 202a could take place in response to one or more known corresponding cylinders (or by one or more equivalent actuators of the locking system). Each cylinder can be actuated by hydraulic, pneumatic or equivalent means.

The container 200 can comprise one or more sensors (not shown) for gathering data relating to the container (for example, the dimensions thereof) and the positioning thereof (for example, the positioning thereof relative to the load space of the truck 400 and/or the positioning thereof relative to the management facility of the type shown in FIG. 11). It will be understood that the term “sensor” (in the singular or in the plural) can refer to one or more devices (including photos, cameras and/or optical sensors). These devices can be configured for performing detection of two-dimensional (2D) and/or three-dimensional (3D) images, 3D depth detection, and/or other types of detection of the physical environment. By using the data captured, the operation of the locking system of the container 200 is satisfactorily managed in real time.

In one embodiment, the sensors can comprise one or more detection sensors (not shown) that detect the presence of one or more tyres in the load space of the container 200. The detection sensors can be selected from among the commercially available sensors (for example, sensors of the reflector type). The detection of a tyre in the load space can trigger a locking method performed by the container 200, which requires management of the locking system. The sensors can further comprise one or more calibration sensors (not shown) that manage the calibration of a vision system of the container 200 (for example, a 2D/3D vision system). The detection sensors and the calibration sensors can be fastened to the container 200 (for example, along one or more movable walls 202, along a length of one or more reinforcements 202ₐᵣ, 202_{br}, and/or along the platform 204). It will be understood that the detection sensors and the calibration sensors are given by way of example. Other sensors having other functions can be provided for use with the container 200 in order to perform the locking method as a function of the properties of the container (for example, the dimensions and positioning thereof, the arrangement of the tyres, etc.).

In a tyre management facility incorporating the container 200, the data gathered by the sensors can be used in the management of an apparatus that picks up the tyres arranged in the container. In one embodiment of the management facility, this apparatus comprises at least one device 100 of the type described above and shown in FIGS. 4 and 5.

In one embodiment of the container 200, the container is provided with identification means (not shown) that make it possible to retain information about the container (including the dimensions thereof, the different possible arrangements of the tyres arranged therein, the different quantities of tyres that can be arranged therein, etc.). These identification means could comprise at least one of one or more RFID codes, one or more bar codes, and one or more equivalent identification means.

In a tyre management facility incorporating the container 200, a vision system can be used to detect the presence of a tyre arrangement in the field of view of a camera of the vision system (for example, the camera 300), which triggers the camera to capture the image of one or more tyres. In instances in which part of the tyre is not visible in the image obtained by the camera, an arbitrary point can be placed in a known position with respect to the sensor of the detection system (for example at a known horizontal distance and at a known vertical distance from the position of the sensor).

The sensors of the container 200, the sensors of the device 100 and the vision system of the management facility 500 can therefore provide information about the physical environment that can be used by a control system (which comprises, for example, software for planning tyre picking and/or locking the container 200, and/or software for controlling the corresponding movements of the device 100). The control system could communicate remotely. In some embodiments, one or more sensors mounted on the device 100 (including, non-limitingly, navigation sensors) can be integrated in order to form a digital model of the physical environment (including, where applicable, the side or sides, the floor and the ceiling). Using the data obtained, the control system can cause the device 100 to move in order to navigate between the target tyre picking positions as a function of the positioning of the container 200 in the management facility 500.

With further reference to FIGS. 1 to 11, and particularly to FIGS. 5, 10 and 11, a detailed description of a management method (or “method”) of the invention is given by way of example.

Prior to initiating the method of the invention, orders for particular tyres are received at the management facility 500 by known means (for example, by one or more communication networks integrated into the facility 500). The facility 500 makes it possible to receive orders until the end of a specified day in order to ensure that they are dispatched in an identified time slot (when the method of the invention starts).

When the method of the invention is initiated, the method comprises a step of performing a picking process. The picking process comprises either the process of picking on the basis of images taken by the device 100 (described above with reference to WO2022/135968 of the applicant) or the process of picking on the basis of few-shot learning (described above with reference to FR2113035 of the applicant).

In some embodiments of the method of the invention in which the picking process comprises the picking process on the basis of images taken by the device 100, the process comprises a step of determining one or more parameters of a target tyre P* in a tyre arrangement. During this step, the device 100 obtains one or more digital images of the tyres P₂₀₀ arranged in an identified container 200 in order to identify the tyre that becomes a candidate for picking (see FIG. 5 and FIG. 11). The container 200 is of the type described and shown with reference to FIGS. 7 to 9 (but it will be understood that a single container 200 or a plurality of containers 200 can be used in the picking space 510).

During this step, the image of the target tyre P₂₀₀* is analysed in order to identify one or more front vertical edges B_{AV} of the tyre in the image (see FIG. 2). During this step, the processor can continue to scan until the inner boundary F_{I} of the sidewall F is identified. During this step, the distance between the front vertical edge B_{AV} and the inner boundary F_{I} is measured in order to determine a height H₁ of the sidewall F of the target tyre. During this step, the data corresponding to the front vertical edges B_{AV} can be used to identify a mid-line M of the target tyre. During this step, the processor can then analyse the image of the target tyre and of the inner boundary F_{I} to calculate the inner boundary F_{I} and a rear vertical edge B_{AR}.

In some embodiments, the camera can capture an image of just part of the target tyre P₂₀₀*, or the image of the target tyre P₂₀₀* can be obstructed by objects in the physical environment (including, non-limitingly, other tyres, one or more operators, or one or more rails). The parameters of the target tyre are determined in both instances, namely when there is no obstacle hiding the target tyre and when at least part of the target tyre is hidden by one or more obstacles (including one of the other tyres arranged with the target tyre).

In this embodiment, the picking process further comprises a step of determining the diameter of the target tyre. This step comprises determining a distance between the imaged front vertical edge B_{AV} and the calculated rear vertical edge B_{AR}. This step comprises determining a distance between the inner boundary F_{I} of the sidewall F and the rear vertical edge B_{AR} in order to calculate a mean sidewall height H₂ corresponding to the size of the target tyre.

In this embodiment, a virtual environment comprising a 2D and/or 3D model of the arranged tyres can be determined and used to formulate a plan or strategy for picking up the tyres. For example, the device 100 can use one or more sensors to scan a physical environment containing the arranged tyres and the one or more target locations, as shown in FIG. 5. The elongated arm 106 and/or the peripheral gripping component 104 move, with one or more sensors on the elongated arm and/or the peripheral gripping component being able to capture data corresponding to the arranged tyres so as to determine the shapes and/or the positions of the individual tyres.

In this embodiment, the picking process further comprises a step of determining the tyre radius R_{P} and rim radius R_{J} of the target tyre P_{200*}. During this step, the tyre radius R_{P} of the target tyre P₂₀₀* can be determined as being half the diameter of the target tyre. During this step, the rim radius R_{J} of the target tyre P₂₀₀* can be determined as being half the diameter of the inner boundary F_{I} of the sidewall of the target tyre. During this step, the central point C can be identified as being a distance from the rim radius R_{J} to the front vertical edge B_{AV} or to the rear vertical edge B_{AR} and situated along the mid-line M.

Knowing the tyre radius R_{P} and the rim radius R_{J} of the target tyre P₂₀₀* would allow the image processing module to determine the location of the inner boundary F_{I} and outer boundary F_{E} of the sidewall F of the target tyre. Knowing the mean height H₂ of the sidewall and the tyre radius R_{P} of the target tyre would allow the processor to determine the size of the target tyre. The relevant parameters of the target tyre can thus be determined, for example, from the tyre-size reference, or generated by an equation.

In this embodiment, the picking process further comprises a step of picking up the target tyre P₂₀₀* (see FIG. 5). This step comprises an approach step in which the gripper 108 approaches the target tyre P₂₀₀* and the picking up of the target tyre at a pick-up point along the tread surface Sₚ* of the target tyre and a pick-up point of the inner boundary F_{I} of the sidewall F. During this step, the device 100 holds the sidewall F and the tread surface S_{P*}of the target tyre P₂₀₀*.

In this embodiment, the picking process comprises a final step of extracting the tyre P₂₀₀* from the arrangement in order to place it in a predetermined location (for example, in the truck 400). This step comprises a step of transporting the target tyre P₂₀₀* to the predetermined location, this step being performed by the device 100.

In some embodiments of the method of the invention in which the picking process comprises the picking process on the basis of few-shot learning, the process starts with step 1002 of acquiring data corresponding to the arranged tyres. With reference to FIG. 6, during this step, the detection system (for example, one or more RGB-D cameras incorporated into the picking space 510) captures an initial image of the tyres P₂₀₀ randomly arranged in an unknown location (for example, a container 200). In this example, a plurality of overlapping tyres P₂₀₀ appears in the field of view of the detection system. During this step, a point cloud is constructed from the RGB-D images as described above.

The few-shot learning process continues with the step 1004 of feeding the extraction network and the attention network. In one embodiment of the method, this step can comprise a step of segmenting the data based on a plurality of cycles of a repetitive movement of the device 100 during one or more picking cycles. This step comprises the step 1004b of feeding the extraction network and the attention network (as described above with reference to the process 1000 shown in FIG. 6).

The few-shot learning process continues with step 1006 of implementing a three-dimensional (3D) reconstruction process that is used to provide the geometric information required to generate the ideal pick-up point for the device 100. The 3D reconstruction process comprises a reconstruction process that is wholly carried out on the basis of the data from the extraction and attention networks. During this step, the orientation, dimensions and location of the identified target tyre P₂₀₀* are reconstructed from this information data. During this step, the detection system constructs a virtual tyre in the form of a cylinder on the visible surface of the cluster representing a target tyre. During this step, the centre of the identified target tyre P₂₀₀* is identified in order to estimate its inner and outer diameters. Once the attention network learns the location of the target tyre and its orientation, it sends the corresponding coordinates (for example, the X, Y, Z coordinates and the orientation of the tyre axis) to the device 100.

In this embodiment, the picking process continues with the approach step 1008 in which the device 100 approaches the identified target tyre P_{200*}for picking. This step comprises an approach step in which the device 100 approaches the identified target tyre P_{200*}. This step further comprises a step of picking up the identified target tyre P_{200*} at the ideal pick-up point (as calculated during step 1006). For the configuration of the device 100 as shown in FIGS. 4 and 5, during this step, the gripper 108 is managed so that it engages a sidewall of the identified target tyre P_{200*} (for example, towards a pick-up point of the inner boundary F_{I} of the sidewall F).

In this embodiment, the picking process comprises a final step of extracting the identified target tyre P_{200*} from the tyre arrangement in order to place it in a target location. This step comprises a step of transporting the identified target tyre P_{200*} to the target location that is carried out by the device 100.

The preceding steps can easily be repeated in a sequence for satisfactorily arranging the tyres in a target arrangement.

Few-shot learning aims to recognize new visual categories from very few labelled examples. With reference to the device 100, the initial positioning of the device 100 (and, where applicable, the initial orientation of the gripper 108) is determined from data obtained via the acquisition of images of the management system and the physical environment in which the management system operates (for example, the picking space 510 shown in FIG. 11).

The selected picking process is performed in a dedicated picking space that is shown in FIG. 11 by the picking space 510 of the management facility 500. The picking space 510 can include one or more target locations for the tyres intended for picking. It will be understood that a dedicated picking space could comprise a warehouse or other known equivalent storage space in which a variety of tyres is stored. Such a space can be installed a long distance from the management facility 500.

The method of the invention further comprises a step of performing a process of loading one or more containers 200. The containers 200 are dedicated to one or more orders received at the facility 500 before the initiation of the picking process. The number and variety of the tyres picked and then loaded into the containers 200 are determined as a function of this order.

The loading process comprises a step of positioning one or more containers 200 in the picking space (and/or in an equivalent loading space) of the facility 500 (see FIG. 5). During this step, a target container 200* is identified as a target location for the tyres picked during the picking process. The target container 200* remains on standby in the unlocked position (shown in FIG. 7) so that the device 100 can load the target container with the picked tyres. During this step, a facility in which the target container 200* is positioned can be stopped and made safe in order to allow uninterrupted access to the target container.

The loading process further comprises a step of loading the target container 200*. During this step, the device 100 arranges the tyres picked during the picking process in the target container 200* (but it will be understood that the target container 200* could be loaded by other equivalent handling means). During this step, the device 100 loads the target container 200* in a planned arrangement (for example, a rick-rack arrangement as shown in FIG. 1). This planned arrangement is based on the parameters of the picked tyres. In order to arrive at the planned arrangement, the system of the invention also performs a picking process in which the picked tyres are arranged in the planned arrangement. The precise arrangement will depend on the order received at the management facility 500.

The loading process further comprises a step of locking the target container 200* in order to press it against the tyres arranged therein. During this step, the locking ends 202a″′, 202b″′ of each movable wall 202 of the target container 200* move towards each other so that the movable walls tilt to the locked position (see the arrows A, A′ in FIG. 7). The coming together of the movable walls 202 compacts the tyres arranged inside the target container 200* so as to immobilize them and hold them in the planned arrangement during the transport of the target container 200*.

During this step, the detection of the presence and satisfactory positioning of the tyres in the target container 200* (performed, for example, by one or more detection sensors and/or one or more calibration sensors) makes it possible to move the upper part 202a of each movable wall 202 from the unlocked position (see FIG. 7) to the locked position (see FIG. 8) in order to immobilize and firmly position the tyres in the container. This configuration, which ensures that the tyres are retained in the load space of the target container 200*, also optimizes a working zone of an apparatus that processes the tyres arranged in the container (for example, the device 100).

In some embodiments of the method of the invention, the method of the invention further comprises a step of provisioning transport means. During this step, the arranged tyres can be provided in containers by automatic handling means (for example, of the AGV/RGV type) and/or by other means (see the vehicle 700 in FIG. 10). It will be understood that the filled containers could be arranged in the transport means by any other manual or semi-automatic handling means. During this step, the filled containers are loaded into the transport means in a predetermined sequence that makes it possible to process the orders received at the facility 500 in a corresponding sequence. The tyres are therefore transported so as to allow unloading that mirrors the loading of the containers into the transport means.

The transport means is of the type selected for transporting the containers filled with tyres from the picking space 510 to a sorting facility 520 (shown in FIG. 11). By way of example, the selected transport means is represented by the truck 400 (see FIG. 10). It will be understood that the system of the invention is ready to perform the provisioning step in relation to any transport means capable of accepting and transporting the containers 200.

The method of the invention further comprises a step of transporting the filled containers from a loading space (for example, the picking space 510) to a processing space (for example, the sorting facility 520). Once this journey has been made, the transport means (for example, the truck 400) is ready to allow the rapid unloading of the containers 200 mirroring the loading thereof.

The method of the invention further comprises a step of unloading the transport means (or “unloading step”) at the sorting facility 520 (see FIG. 11). During this step, each filled container 200 is placed on a dock 522 in the reverse sequence with respect to the loading thereof. On the dock 522, the upper and lower parts 202a, 202b of each movable wall 202 are unlocked, allowing the spring-loaded coupling system to urge the upper parts 202a to the unlocked position (see FIG. 8). The upper part 202a of each movable wall 202 is set in linear alternating movement to the standby position (see FIGS. 7 and 8), which makes it possible to unload the tyres arranged in the container 200.

The unloading step of the method of the invention comprises a step of dumping the tyres (shown in FIG. 11 by the dumped tyres P₅₀₀) onto circulation means installed at the sorting facility 520. As shown in FIG. 11, the circulation means can comprise a conveyor 530, a belt or other known equivalent circulation means. The conveyor 530 circulates in a predetermined direction (shown by the arrow B in FIG. 11) to convey the dumped tyres P₅₀₀ to one or more workstations 540 where corresponding fixed robots collect the circulating tyres. It will be understood that the conveyor 530 could circulate in the opposite direction. It will also be understood that the circulation means could comprise a pair of conveyors wherein one conveyor circulates in the direction of the arrow B and the other conveyor circulates in the opposite direction.

The method of the invention further comprises a step of collecting dumped tyres P₅₀₀ (or “collecting step”) as a function of one or more orders received at the facility 500. During this step, the conveyor 530 conveys the dumped tyres P₅₀₀ to the workstations 540. At each workstation 540, a fixed robot is assigned to collecting the tyres intended to fulfil one or more orders in progress. The fixed robot can comprise at least one device 100 of the type described above and shown in FIGS. 4 and 5.

The collecting step of the method of the invention comprises a step of performing a picking process in which the robot assigned to a corresponding workstation 540 uses vision algorithms and a gripping system (for example, the gripper 108 of the device 100) to select and collect one or more tyres as a function of an assortment of tyres intended for arrangement in a target location. During this step, the picking process comprises either the picking process on the basis of images taken by the device 100 or the picking process on the basis of few-shot learning (both described above and shown with reference to FIGS. 1 to 3 and 5 to 6). During this step, the robot assigned to a workstation 540 identifies the tyre or tyres intended for arrangement in a target location positioned at the workstation. By way of example, one fixed robot at a corresponding workstation 540 can be dedicated to collecting circulating tyres having predefined parameters. By way of example, one fixed robot at a corresponding workstation 540 can be dedicated to collecting identified circulating tyres in order to fulfil a specific order. The two robots can work simultaneously so that the system of the invention can fulfil several orders at once.

Following the collecting step, the method of the invention comprises a step of loading a target location 550 positioned at each workstation 540. During this step, the robot (that is, the device 100) picks up the tyres identified during the collecting step, and places them in the assigned target location 550. The target location 550 could comprise one or more containers (including one or more containers 200 as shown in FIGS. 7 to 9) and/or one or more other equivalent containers suitable for performing a distribution method on the tyres arranged therein (the container being selected from, for example, pallets, open-bodies of trucks, chain-bound beds of trucks, box-bodies of trucks or vans and equivalents thereof). Using the module for executing the analysis application, each robot determines the optimum arrangement of the collected tyres in the arrangement space of the target location. During this step, the system of the invention is capable of relating the parameters of the tyres identified on the conveyor 530 to the dimensions of the arrangement space of the target location 550 at the corresponding workstation 540. The robots are thus able to share out the tyres circulating on the conveyor 530 to be picked up and able to know when the collecting work is complete.

The method of the invention comprises a final step of positioning the target locations 550 (filled with the identified tyres) in one or more distribution systems serving the facility 500.

During this step, the distribution system or systems remove the arranged tyres in order to eventually deliver them.

It will be understood that the sorting and removal of the tyres at the facility 500 take place concurrently with the unloading of the transport means and independently of the manual operations. Significant gains are therefore made in aspects of productivity by finding, identifying and extracting the identified tyres for fulfilling orders.

It will also be understood that the method could be performed in reverse: the tyres ordered at the facility 500 can be identified on the conveyor 530 by the robots at one or more workstations 540 in order to place them in one or more corresponding containers 200. The filled containers 200 could be loaded onto transport means (for example, the truck 400) to travel to a picking space 510. The tyres are unloaded from the transport means and are stored in the picking space until an order must be fulfilled.

In some embodiments of the method of the invention, one or more steps of the method can further comprise a step of scanning the physical environment containing the picking space 510 and/or the physical environment containing the sorting space 520 (including the conveyor 530). In some embodiments of the method, this step further comprises a step of measuring the physical environment in order to arrive at an exact positioning of the container 200. During this step, one or more sensors can be used to capture data corresponding to the locked containers 200 and to the arranged/dumped tyres in order to determine the shapes and/or positions of the individual tyres. This information is relevant for understanding the arrangement of the arranged tyres and determining the best candidate for picking up among the arranged tyres. This strategy of selecting the best candidate allows for precise modelling of the method in order to optimize the time of an associated picking process.

A method of the invention can be performed under the control of the PLC and can include pre-programming of management information. For example, a setting of the method can be associated with the parameters of the container 200 and/or the properties of the tyre arranged in a container (including the properties of one or more types of tyres associated with the corresponding containers). The system of the invention (and/or a facility incorporating said system) can easily repeat one or more steps of the method in a given sequence in order to satisfactorily supply the tyres ordered to obtain a desired tyre order.

The system of the invention (and/or a facility incorporating said system) can include preprogrammed management information. For example, a setting of the method can be associated with the parameters of the typical physical environments in which the system operates. In some embodiments of the invention, the system (and/or a facility incorporating said system) can receive voice commands or other audio data representing, for example, a command to start or stop the conveyor 530 and/or a command to load/unload a container 200. The request can include a request for the current status of a cycle of the automatic recognition method. A generated response can be represented in an audible, visual or tactile manner (for example, using a haptic interface) and/or in a virtual and/or augmented manner. This response, associated with the corresponding data, can be recorded in a neural network.

A monitoring system could be implemented for all of the embodiments of the system. At least part of the monitoring system can be provided in a portable device such as a mobile network device (for example a mobile telephone, a laptop computer, one or more portable devices connected to the network (including “augmented reality” and/or “virtual reality” devices), wearable clothing connected to the network and/or any combinations and/or any equivalents thereof). It is conceivable for detection and comparison steps to be able to be performed iteratively.

In one embodiment, the method can comprise a step of training a system of the invention to recognize values representing the containers and/or the parameters of the tyres associated with the containers managed by the system (for example, the values of the inner diameter and the outer diameter) and to perform a comparison with target values (for example, in order to produce a batch incorporating the picked tyres). Each training step can include a classification generated by self-learning means. This classification can include, non-limitingly, the parameters of the tyres selected, the configurations of the containers, the durations of the method cycles and the values expected at the end of a method in progress (for example, the number of tyres placed in the target location in order to fulfil a desired order).

The terms “at least one” and “one or more” are used interchangeably. Ranges presented as lying “between a and b” include the values “a” and “b”.

Although particular embodiments of the disclosed apparatus have been illustrated and described, it will be understood that various changes, additions and modifications can be made without departing from the spirit or the scope of the present disclosure. Consequently, no limitation should be imposed on the scope of the described invention, apart from those disclosed in the appended claims.

1-15. (canceled)

16. A method for managing loading and unloading of tires arranged in an unknown arrangement, the method being implemented by a system that executes programmed instructions stored in a memory of one or more processors of the system to manage movement of a picking device to fulfil tire orders received, the method comprising the following steps:
a step of performing a picking process in a dedicated loading space of a management facility incorporating one or more target locations for tires intended for picking;
a step of performing a process of loading one or more dedicated target locations for processing orders received at the management facility before initiation of the picking process;
a step of transporting the loaded one or more target locations from the dedicated loading space to a processing space of the management facility;
an unloading step performed in the processing space of the management facility;
a step of collecting tires as a function of the orders received at the management facility, during which the unloaded tires are conveyed to at least one workstation with a fixed robot comprising at least one device assigned to collecting the unloaded tires intended to fulfil one or more orders in progress;
a step of loading a target location assigned to each workstation, during which the device picks up the tire or tires identified during the collecting step and arranges the tire or tires in the target location assigned to each workstation; and
a step of positioning the loaded target locations assigned to each workstation in one or more distribution systems serving the management facility, during which each distribution system is capable of removing the arranged tires in order to fulfil each order received in a predetermined sequence.

17. The method according to claim 16, wherein the picking process comprises a process of picking on a basis of one or more images taken by the picking device comprising the following steps:
a step of determining one or more parameters of a target tire in the unknown tire arrangement, during which the device obtains one or more digital images of stored tires in order to identify a tire that becomes a candidate for picking up, and in which parameters of the imaged target tire comprise at least one parameter among the following parameters:
an inner boundary and an outer boundary that together define boundaries of the sidewall of the target tire;
a rim radius defined as being a distance between a central point of the target tire and the inner boundary of the sidewall;
a sidewall inner diameter defined as being twice the rim radius;
a tire radius defined as being a distance between the central point and the outer boundary of the sidewall; and
a tire diameter defined as being twice the tire radius;
a step of determining the diameter of the target tire;
a step of determining the tire radius and rim radius of the target tire;
an approach step in which the device approaches the target tire for picking up;
a picking step in which the target tire is picked up by a gripper; and
a step of extracting the target tire from the tire arrangement in order to place the target tire in a target location,
wherein, during the step of determining one or more parameters of the target tire, the picking device obtains one or more digital images of the tires arranged in an identified target location in order to identify the tire that becomes the candidate for picking.

18. The method according to claim 16, wherein the picking process comprises a process of picking on a basis of few-shot learning comprising the following steps:
a step of acquiring data corresponding to the arranged tires, during which a detection system of the picking device captures an initial image of the arranged tires;
a step of feeding an extraction neural network and an attention neural network, during which both neural networks are trained by taking a plurality of sample images obtained during the data acquisition step as training data and a plurality of classifications of objects in images as data labels;
a step of performing a three-dimensional reconstruction process wholly performed based on the data from the extraction neural network and the attention neural network, during which coordinates corresponding to a location of an identified target tire and an orientation of the identified target tire are reconstructed from the data, so that the reconstruction can be used to provide geometric information required to generate an ideal pick-up point on the identified target tire;
an approach step in which the picking device approaches the identified target tire, during which the attention neural network sends the coordinates corresponding to the location of the identified target tire and the orientation of the identified target tire to the picking device; and
a step of extracting the identified target tire from the tire arrangement in order to place it in the target location.

19. The method according to claim 18, wherein the step of feeding the extraction neural network and the attention neural network comprises the following steps:
a step of training the extraction neural network to segment a scene viewed by the detection system of the management system; and
a step of constructing an attention mechanism, during which the attention neural network extracts differentiated properties from among various categories in a target tire detection model, such that the model is guided in order to locate key areas in a segmented image,
wherein the step of training the extraction neural network comprises a step of segmenting data based on a plurality of cycles of a repetitive movement of the picking device during one or more picking cycles.

20. The method according to claim 15, wherein, during the step of performing the 3D reconstruction process, the orientation, dimensions and location of the identified target tire are reconstructed from the data from the extraction neural network and the attention neural network.

21. The method according to claim 19, wherein the step of acquiring data of the few-shot learning process comprises a step of constructing a point cloud from one or more RGB-D images, and
wherein the approach step of the picking device comprises a step of picking up the identified target tire at the ideal pick-up point calculated during the step of performing the 3D reconstruction process.

22. The method according to claim 17, wherein the step of extracting the identified target tire comprises a step of transporting the identified target tire to a predetermined target location via the picking device.

23. The method according to claim 17, wherein the picking process comprises the following steps:
a step of providing a detection system comprising one or more sensors for capturing one or more images of the physical environment around the picking device incorporating the tire arrangement and for gathering representative data in a field of view of the sensors; and
a step of providing a processor comprising an image processing module that applies the representative data to a deployed neural network and analyzes the captured images in order to determine, using the deployed neural network, one or more parameters of a target tire imaged in the field of view of the sensors such that the device is set in motion on a basis of the determined parameters of the target tire, so that the gripper can pick up a target tire selected by the detection system.

24. The method according to claim 16, wherein the unloading step comprises a step of dumping the tires received at the facility onto circulation means installed in the processing space of the management facility, which circulation means circulate in a predetermined direction in order to convey the dumped tires to one or more workstations of the facility.

25. The method according to claim 24, wherein the collecting step comprises a step of performing a picking process, during which the robot assigned to a workstation identifies the tire or tires intended for arrangement in a target location positioned at the workstation.

26. The method according to claim 16, wherein one or more steps of the picking process are repeated in a predetermined sequence in order to arrange the tires in a predetermined target arrangement.

27. The method according to claim 16, wherein the step of transporting the loaded target locations comprises a step of provisioning transport means, during which the loaded target locations are arranged in the transport means in a predetermined sequence that makes it possible to process the orders received at the facility in a corresponding sequence.

28. The method according to claim 16, further comprising a step of performing a locking method performed by a container used as a target location positioned in at least one of the loading space and a target location assigned to each workstation, the container comprising:
a substantially rectangular retaining frame in order to make it possible to load and retain the tires in the container;
a pair of substantially identical movable walls; and
a depositing platform comprising an upper surface to which the movable walls are tiltably connected, and an opposite lower surface,
wherein each movable wall comprises an upper part and a lower part that form a system for compacting the container, and
wherein the upper part comprises substantially parallel elements having a predetermined length that extends between a control end and an opposite locking end of the upper part, and the lower part comprises substantially parallel elements having a predetermined length that extends between a fastening end positioned next to the upper surface of the platform and an opposite locking end such that locking ends are positioned next to each other where the movable walls are placed in an unlocked position, where each respective movable wall remains tilted to allow the loading and arrangement of the tires in the container, the substantially parallel elements of the lower part being separated by a predetermined width so that the substantially parallel elements of the lower part are substantially aligned with the substantially parallel elements of the upper part,
wherein the fastening end of the lower part of the container is positioned next to the upper surface of the platform, the fastening end of the lower part comprising one or more known fastening means that facilitate a tilting movement of each movable wall allowing each movable wall to rise and descend pivotably, making it possible to tilt each movable wall between an unlocked position and a locked position, where each movable wall rises to immobilize and firmly position the tires arranged in the container, in which the substantially parallel elements of the upper part and the lower part meet and are locked in order to compact the tires arranged in the container.

29. The method according to claim 28, wherein, during the unloading step:
each filled container is placed in the processing space of the management facility in reverse loading sequence; and
in the processing space, the upper and lower parts of each movable wall are unlocked, which makes it possible to unload the tires arranged in the container.

30. The method according to claim 28, wherein the loading process comprises the following steps:
a step of positioning one or more containers in the picking space of the facility, during which a target container is identified as a target location for one or more tires picked during the picking process;
a step of loading the target container during which a picking device arranges the picked tires in the target container in a planned arrangement based on the parameters of the picked tires; and
a step of locking the target container in order to press the target container against the tires arranged therein, during which the locking ends of each movable wall of the target container move toward each other in order to immobilize the tires arranged in the target container and keep the tires in the planned arrangement during transport of the target container.
